(19) United States
(12) Patent Application Publication
(10) Pub. No.: US 2011/0047004 A1
(43) Pub. Date: Feb. 24, 2011

(54) MODELING CAUSAL FACTORS WITH SEASONAL PATTTERNS IN A CAUSAL PRODUCT DEMAND FORECASTING SYSTEM

(76) Inventors: Arash Bateni, Toronto (CA); Edward Kim, Toronto (CA)

Correspondence Address: JAMES M. STOVER;TERADATA CORPORATION, 10000 INNOVATION DRIVE, DAYTON, OH, 45342, US

(21) Appl. No.: 12/545,263

(22) Filed: Aug. 21, 2009

(51) Int. Cl. G06Q 10/00

(52) U.S. Cl. 705/10

(57) ABSTRACT

A method and system for forecasting product demand using a causal methodology, based on multiple regression techniques. In order to better predict product demand changes associated with causal variables having seasonal patterns, such as temperature, the method and system include a technique for removing the seasonal variation of causal variables, i.e., to de-seasonalize the causal factors. The de-seasonalized causal variables are utilized within the causal methodology to generate product demand forecasts.

### CROSS REFERENCE TO RELATED APPLICATIONS

This application is related to the following co-pending and commonly-assigned patent applications, which are incorporated by reference herein:

Application Ser. No. 11/613,404, entitled “IMPROVED METHODS AND SYSTEMS FOR FORECASTING PRODUCT DEMAND USING A CAUSAL METHODOLOGY,” filed on Dec. 20, 2006, by Arash Bateni, Edward Kim, Philip Liew, and J. P. Vorsanger;

Application Ser. No. 11/938,812, entitled “IMPROVED METHODS AND SYSTEMS FOR FORECASTING PRODUCT DEMAND DURING PROMOTIONAL EVENTS USING A CAUSAL METHODOLOGY,” filed on Nov. 13, 2007, by Arash Bateni, Edward Kim, Harmintar Atwal, and J. P. Vorsanger;

Application Ser. No. 11/967,645, entitled “TECHNIQUES FOR CAUSAL DEMAND FORECASTING,” filed on Dec. 31, 2007, by Arash Bateni, Edward Kim, J. P. Vorsanger, and Rong Zong; and

Application Ser. No. 12/255,696, entitled “METHODOLOGY FOR SELECTING CAUSAL VARIABLES FOR USE IN A PRODUCT DEMAND FORECASTING SYSTEM,” filed on Oct. 22, 2008, by Arash Bateni and Edward Kim.

Application Ser. No. 12/512,071, entitled “CAUSAL PRODUCT DEMAND FORECASTING SYSTEM AND METHOD USING WEATHER DATA AS CAUSAL FACTORS IN RETAIL DEMAND FORECASTING,” filed on Jul. 30, 2009, by Arash Bateni and Edward Kim.

### FIELD OF THE INVENTION

The present invention relates to a methods and systems for forecasting product demand using a causal methodology, based on multiple regression techniques, and in particular to a method for de-seasonalizing causal factors having strong seasonal patterns and using the deseasonalized variables within the causal demand forecasting methodology.

### BACKGROUND OF THE INVENTION

Accurate demand forecasts are crucial to a retailer's business activities, particularly inventory control and replenishment, and hence significantly contribute to the productivity and profit of retail organizations.

Teradata Corporation has developed a suite of analytical applications for the retail business, referred to as Teradata Demand Chain Management (DCM), which provides retailers with the tools they need for product demand forecasting, planning and replenishment. Teradata Demand Chain Management assists retailers in accurately forecasting product sales at the store/SKU (Stock Keeping Unit) level to ensure high customer service levels are met, and inventory stock at the store level is optimized and automatically replenished. Teradata DCM helps retailers anticipate increased demand for products and plan for customer promotions by providing the tools to do effective product forecasting through a responsive supply chain.

In application Ser. Nos. 11/613,404; 11/938,812; and 11/967,645, referred to above in the CROSS REFERENCE TO RELATED APPLICATIONS, Teradata Corporation has presented improvements to the DCM Application Suite for forecasting and modeling product demand during promotional and non-promotional periods. The forecasting methodologies described in these references seek to establish a cause-effect relationship between product demand and factors influencing product demand in a market environment. Such factors may include current product sales rates, seasonality of demand, product price changes, promotional activities, competitive information, and other factors. A product demand forecast is generated by blending the various influencing causal factors in accordance with corresponding regression coefficients determined through the analysis of historical product demand and factor information.

This process for forecasting product demand using a causal methodology is more complex when dealing with casual factors with seasonal patterns. It is more difficult to identify a significant relationship between product demand and a seasonal variable. These variables may appear to have strong relationships with seasonal products, however, such a correlation may be due to the seasonality of both demand and the causal variable, and thus may not be an indication of a true causal relationship.

Even when a significant relationship exists between a seasonal variable and product demand, a change in the value of the seasonal variables does not necessarily translate to a corresponding change in product demand. Research suggests that it is often an unexpected change in a causal factor that triggers significant uplifts in demand. Variable changes due to seasonality are often perceived by consumers as normal and hence do not generate an uplift in demand.

Typical examples of causal variables with seasonal patterns are temperature, precipitation and other weather-related factors. Again, research has shown that these variables can serve as leading indicators of demand change, and hence improve product demand forecast accuracy for relevant categories of products. However, variables with strong seasonality must be modeled properly.

Described below is a technique to de-seasonalize causal factors based on their historical values. It is believed that de-seasonalized variables are better predictors of demand change, whose use will result in improved product demand forecast accuracy. The technique introduced herein is generally applicable to most causal variables with a seasonal pattern. However, for simplicity the examples and illustrations are given for modeling temperature.

### BRIEF DESCRIPTION OF THE DRAWINGS

FIG. 1 provides a high level architecture diagram of a web-based three-tier client-server computer system architecture.

FIG. 2 is a flow diagram illustrating a causal methodology for determining product demand forecasts including weather related data as a set of causal factors within the regression analysis and demand forecast calculations.

FIG. 3 provides a graphical comparison between recorded weekly temperatures during an exemplary fifty-two week period and weekly average historical temperatures for those same fifty-two weeks.

FIG. 4 is a simple flow diagram illustrating a process for de-seasonalizing average weekly temperature values.

FIG. 5 is a flow chart illustrating a process for selecting causal variables to be used within a causal forecasting framework.

FIG. 6 shows the structure of a database table for storing causal variable history information during variable selection in accordance with the present invention.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

As stated above, the causal demand forecasting methodology seeks to establish a cause-effect relationship between product demand and factors influencing product demand in a market environment. A product demand forecast is generated by blending the various influencing factors in accordance with corresponding regression coefficients determined through the analysis of historical product demand and factor information. The multivariable regression equation can be expressed as:

y=b₀+b₁x₁+b₂x₂+ . . . +bₖxₖ Equation (1);

where y represents demand; x₁ through xₖ represent causal variables, such as current product sales rate, seasonality of demand, product price, promotional activities, and other factors; and b₀ through bₖ represent regression coefficients determined through regression analysis using historical sales, price, promotion, and other causal data.

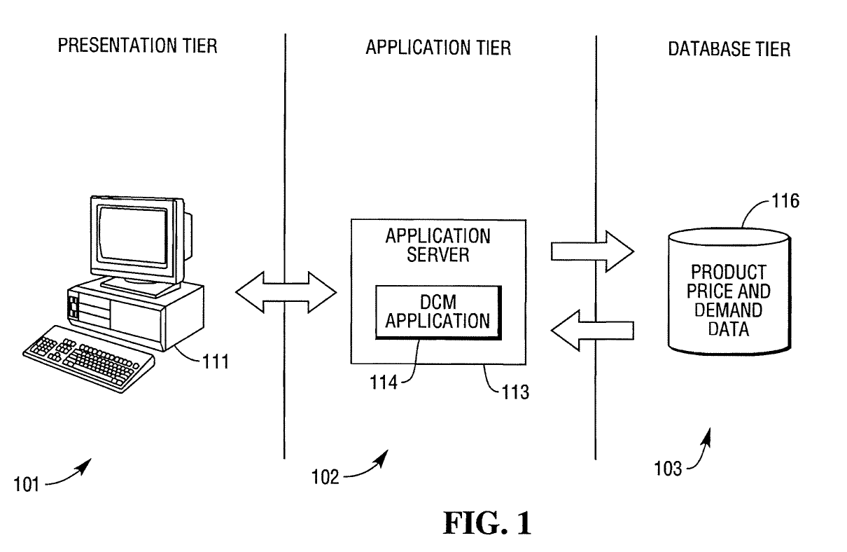

The Teradata Corporation DCM Application Suite may be implemented within a three-tier computer system architecture as illustrated in FIG. 1. The three-tier computer system architecture is a client-server architecture in which the user interface, application logic, and data storage and data access are developed and maintained as independent modules, most often on separate platforms. The three tiers are identified in FIG. 1 as presentation tier 101, application tier 102, and database access tier 103.

Presentation tier 101 includes a PC or workstation 111 and standard graphical user interface enabling user interaction with the DCM application and displaying DCM output results to the user. Application tier 103 includes an application server 113 hosting the DCM software application 114. Database tier 103 includes a database server containing a database 116 of product price and demand data accessed by DCM application 114.

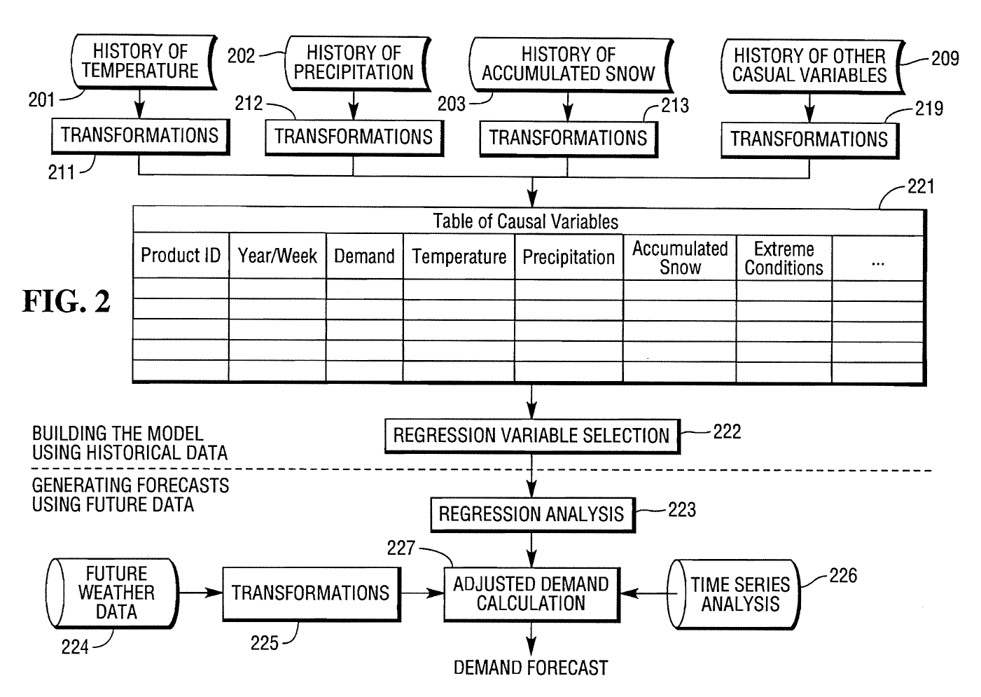

FIG. 2 is a flow diagram illustrating an improved causal methodology for determining product demand forecasts including weather related data as a set of causal factors within the regression analysis and demand forecast calculations. These weather related factors may include temperature, precipitation, snow, accumulated snow, or extreme weather conditions. It is known that the demand of some product categories is driven by such factors. For instance, the demand for umbrellas and snow tires are driven by precipitation and accumulated snow, respectively.

In the causal demand forecasting systems described herein, and illustrated in FIG. 2, both historical and future values of causal factors are needed for causal forecasting. Historical values are used to build the causal model, i.e., to determine the influence of the factor on demand of products, and future values are needed to generate the demand forecasts using the causal model. The future values of the causal factors should be either predictable or known in advance.

The historical values of weather data are readily available. Historical and predicted weather data can be purchased through subscription to a weather service or can be downloaded from established websites. Such data is normally collected at weather stations located at airports. Therefore, the location of a retailer employing a causal demand forecasting system including weather related data as a set of causal factors should be mapped to the closest airport or weather station where weather data is collected.

In FIG. 2, acquired historical temperature data, precipitation data, and accumulated snow data is represented by stored data 201, 202 and 203, respectively.

In steps 211, 212 and 213, stored historical temperature data 201, precipitation data 202, and accumulated snow data 203 is transformed into a format that can be fed into the DCM causal framework. For instance, the collected historical temperature is in the form of maximum, minimum, and average daily values. These values are transformed into weekly average temperatures based on the fiscal retail calendar. Other mathematical transformations may be required from case to case.

Additional weather-related historical casual factor data, not shown, may also be saved, transformed, and fed into the DCM causal framework. Other, non-weather-related, historical casual factor data, represented by stored data 209, is transformed in step 219, and fed into the DCM causal framework.

Causal factor data is compiled for each product or product category as shown by table 221. Table 221 illustrates the collection of weather related causal factor data, e.g., temperature, precipitation, accumulated snow data, and extreme conditions for a portion of a retailers product line, e.g., umbrellas, snow tires, snow shovels, sunscreen, and bottled water. The information displayed in table 221 comprises just a portion of the retailer's product line and a subset of all weather, and non-weather, related causal variables.

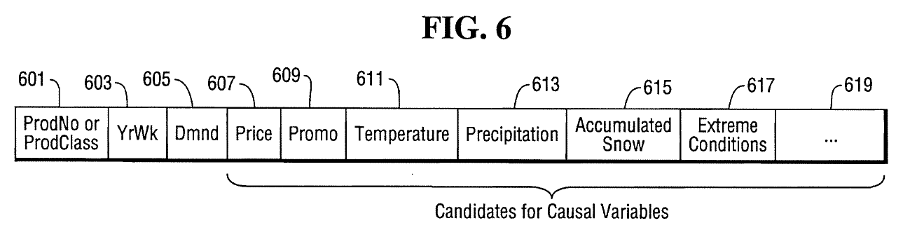

In step 222, causal factor historical data is examined to identify the set of causal weather factors, and other causal factors, that have statistically significant effects on historical product demand, and hence are believed to be of greatest relevance in determining product demand changes in the future, are identified. Additional detail regarding the process for selecting causal variables is illustrated in FIG. 6 and discussed below.

In step 223, regression analysis is performed to determine the regression coefficients for the variables selected in step 222, and to build the multivariable regression equation required for demand forecast calculation.

In step 226 of FIG. 2, the current weekly ARS for a product is calculated from historical demand data. In step 227, the product demand forecast is determined by blending the Average Rate of Sale (ARS) from step 226 with forecasted weather data factors 224, and other forecasted or known causal factor data, for the product demand forecast period multivariable regression equation required for demand forecast calculation.

Future weather data is generally predictable with sufficient accuracy up to one week into the future. The accuracy of such weather forecasts directly affects the accuracy of demand forecasts derived from the causal framework. A transformation 225 may be required to feed the future weather values into the DCM causal framework.

A stated earlier, research suggests that it is often an unexpected change in a causal factor that triggers significant changes in demand, and that de-seasonalized variables, particularly temperature and other variables with a season pattern, are better predictors of demand change than the unaltered seasonal variables.

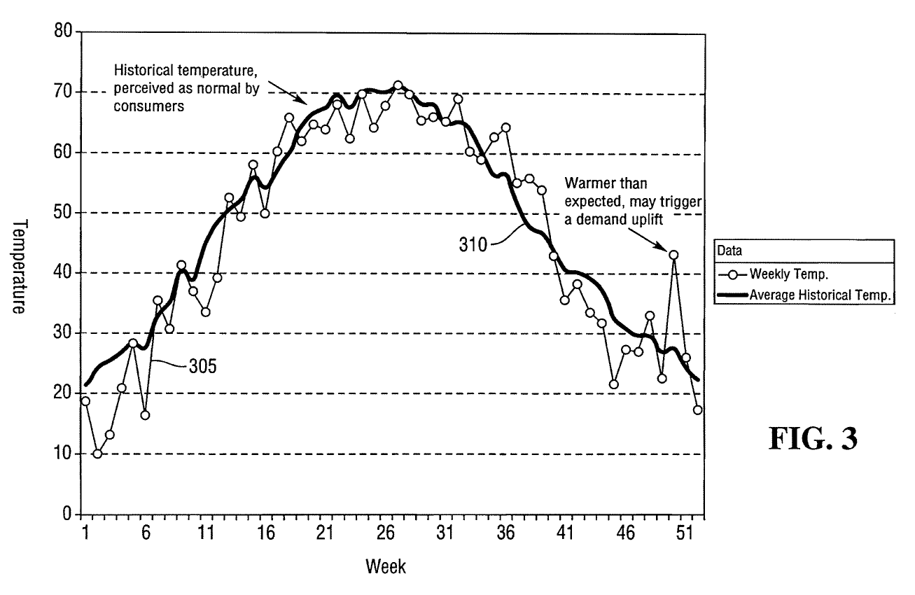

FIG. 3 provides a comparison between recorded weekly temperatures during an exemplary fifty-two week period, represented by line graph 305, and average historical temperatures for those same fifty-two weeks, represented by line graph 310. Large deviations from the historical averages, such as the much colder temperature reported during week 45, or the unexpectedly warm weather of week 50 of the year represented by line graph 305, may trigger significant changes in the demand for certain products.

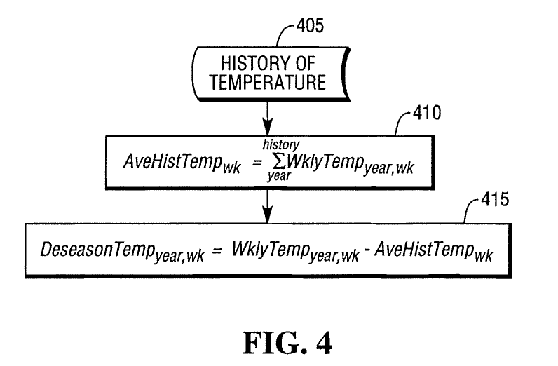

In order to better predict the product demand changes associated with causal variables having seasonal patterns, such as temperature, a technique for removing the seasonal variation of causal variables, i.e., to de-seasonalize the causal factors, based on their historical values is proposed. Referring now to FIG. 4, a process for de-seasonalizing average weekly temperature values will be described.

The history of the causal variable, i.e., temperature, is collected and transformed into a weekly format compatible with DCM's causal framework. The historical temperature data is shown as stored data 405.

In step 410, the average historical weekly temperature is calculated using the available historical temperature data 405 in accordance with Equation (1) provided below:

$${AveHistTemp}_{wk} = {\sum }_{year}^{history} {WklyTemp}_{year , wk} . \qquad Equation ( 2 )$$

De-seasonalized weekly temperature thereafter calculated in step 415 by subtracting the average historical weekly temperature from the current or forecast average weekly temperature:

DeseasonTemp_{year,wk}=WklyTemp_{year,wk}−AveHistTemp_{wk} Equation (3).

Please note that typically variables are de-seasonalized or normalized using multiplicative transformations such as:

DeseasonTemp_{year,wk}=WklyTemp_{year,wk}/AveHistTemp_{wk} Equation (4).

However, due to theoretical reasons, supported by empirical results, additive transformation Equation (3) is recommended for weather variables such as temperature and precipitation.

Incorporating the process for de-seasonalizing select causal variables having seasonal patterns into the process illustrated in FIG. 2, such as including de-seasonalization in transformation steps 211-219 and 225, can provide a better prediction of demand changes for seasonal, and other, products.

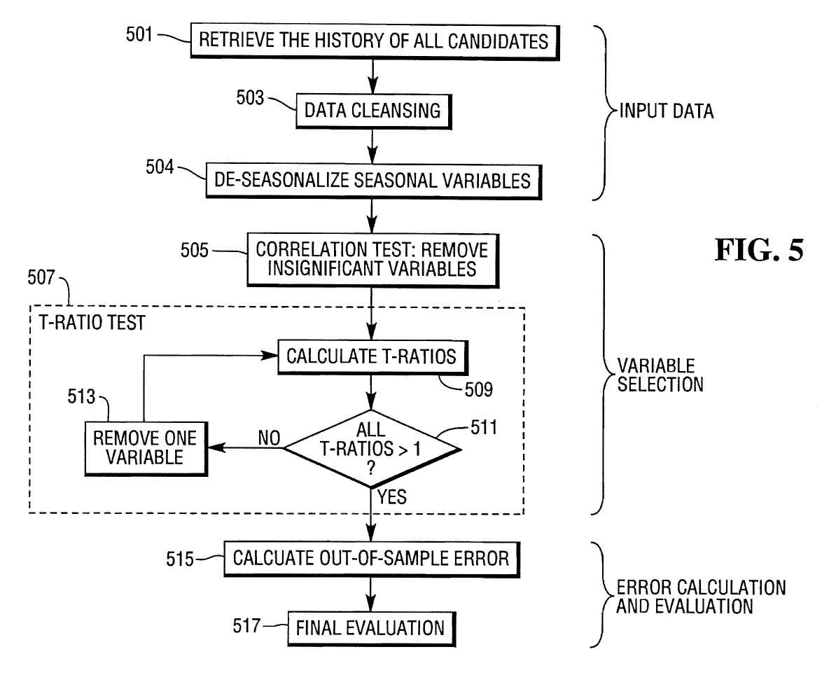

A process for selecting causal variables, including de-seasonalized variables and referred to in step 222 of FIG. 2, to determine whether a variable is a significant predictor for a given category of products is illustrated in FIG. 5.

The regression variable selection process of FIG. 5 begins with the retrieval of historical sales data and causal factor data for a product or product group from data storage in step 501. The history of the product's demand (dependant variable) and all other variables (candidates) required for the selection analysis are stored in a table with one column per variable, as illustrated in FIG. 6. FIG. 6 shows one row of the table. Data stored within the table for each week of product demand includes: a product or product group identification, ProdNo 601; an identification of the week and year of the demand data, YrWk 603; the product or product group demand for the identified week, Dmnd 605; and causal variables Price 607 (calculated as total dollars/total demand), Promo 609, Temperature 611; Precipitation 613, Accumulated Snow 615, Extreme Conditions 617 and other causal variables 619. The causal variables identified in FIG. 6 are not intended to comprise a complete listing of possible variables.

In step 503 data cleansing is performed to remove product demand data corresponding to a stock-out condition, and to remove incomplete weeks, e.g., when the value of one or more variables is missing.

Causal variables having seasonal variation, e.g. temperature or accumulated snow, are de-seasonalized according to the process of FIG. 4 in step 504.

In step 505 the correlation of demand with each of the causal variables is calculated. If the correlation is insignificant, the variable is removed from the regression equation.

In step 507, a multi-regression model is constructed with regression coefficients calculated for each of the causal factors that passed step 505. T-ratios are calculated for each coefficient (step 509) and the variables with smallest absolute t-ratios, are removed iteratively, until the absolute value of all t-ratios>1 (steps 611 and 613).

In step 515 an out-of-sample error calculation is performed to confirm that all the variables contribute to forecast accuracy, i.e., the accuracy is deteriorated if any of the variables is removed. It is recommended that the process be repeated with different variable sets to confirm that each variable is actually contributing to forecast accuracy.

A final evaluation to verify coefficient selection is performed in step 517. Tests are performed to verify that the amount of historical data is adequate to support the selection process, e.g. the number of complete weeks of history divided by the number of variables exceeds 20.

### CONCLUSION

The Figures and description of the invention provided above reveal an improved method and system for forecasting product demand using a causal methodology, based on multiple regression techniques, the improvement including a process for de-seasonalizing causal factors having seasonal variations, such as temperature.

Instructions of the various software routines discussed herein, such as the methods illustrated in FIGS. 2 and 4 are stored on one or more storage modules in the system shown in FIG. 1 and loaded for execution on corresponding control units or processors. The control units or processors include microprocessors, microcontrollers, processor modules or subsystems, or other control or computing devices. As used here, a “controller” refers to hardware, software, or a combination thereof. A “controller” can refer to a single component or to plural components, whether software or hardware.

Data and instructions of the various software routines are stored in respective storage modules, which are implemented as one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

The instructions of the software routines are loaded or transported to each device or system in one of many different ways. For example, code segments including instructions stored on floppy disks, CD or DVD media, a hard disk, or transported through a network interface card, modem, or other interface device are loaded into the device or system and executed as corresponding software modules or layers.

The foregoing description of various embodiments of the invention has been presented for purposes of illustration and description. It is not intended to be exhaustive or to limit the invention to the precise form disclosed. Many alternatives, modifications, and variations will be apparent to those skilled in the art in light of the above teaching. Accordingly, this invention is intended to embrace all alternatives, modifications, equivalents, and variations that fall within the spirit and broad scope of the attached claims.

What is claimed is:

1. A computer-implemented method for forecasting product demand for a product during a future sales period, the method comprising the steps of:
maintaining, on a computer, an electronic database of historical product demand information and historical causal variable data;
identifying a causal variable having a seasonal pattern influencing demand for said product;
removing, by said computer, the seasonal pattern from said historical causal variable data associated with said causal variable to generate de-seasonalized causal variable data for said causal variable;
analyzing, by said computer, said historical product demand information and said de-seasonalized causal variable data for said product to determine a regression coefficient corresponding to said causal variable;
calculating, by said computer, an initial demand forecast for said product during said future sales period from said historical demand information;
receiving, at said computer, a forecast value for said causal variable during said future sales period;
removing, by said computer, the seasonal pattern from said forecast value for said causal variable to generate a de-seasonalized forecast value for said causal variable; and
blending, by said computer, said initial demand forecast, said regression coefficient and said de-seasonalized forecast value for said causal variable to determine a product demand forecast for said product.

2. The computer-implemented method according to claim 1, wherein:
said step of removing, by said computer, the seasonal pattern from said historical causal variable data associated with said causal variable to generate de-seasonalized causal variable data for said causal variable comprises the step of:
determining, by said computer, average historical values for said causal variable from said historical causal variable data; and
subtracting, by said computer, said average historical values from corresponding historical values within said historical causal variable data; and
said step of removing, by said computer, the seasonal pattern from said forecast value for said causal variable to generate a de-seasonalized forecast value for said causal variable comprises the step of:
subtracting, by said computer, a corresponding one of said average historical values from said forecast value for said causal variable.

3. The computer-implemented method according to claim 1, wherein:
said step of removing, by said computer, the seasonal pattern from said historical causal variable data associated with said causal variable to generate de-seasonalized causal variable data for said causal variable comprises the step of:
determining, by said computer, average historical values for said causal variable from said historical causal variable data; and
dividing, by said computer, corresponding historical causal variable data values by said average historical values; and
said step of removing, by said computer, the seasonal pattern from said forecast value for said causal variable to generate a de-seasonalized forecast value for said causal variable comprises the step of:
dividing, by said computer, said forecast value for said causal variable by a corresponding one of said average historical values.

4. The computer-implemented method according to claim 1, wherein said causal variable comprises a temperature variable.

5. The computer-implemented method according to claim 1, wherein said causal variable comprises an accumulated snowfall variable.

6. The computer-implemented method according to claim 1, wherein said causal variable comprises a precipitation variable.

7. A system for forecasting product demand for a product during a future sales period, the system comprising:
a computer storage device containing a database of historical product demand information and historical causal variable data for a plurality of products; and
a processor for:
identifying a causal variable having a seasonal pattern influencing demand for said product;
removing the seasonal pattern from said historical causal variable data associated with said causal variable to generate de-seasonalized causal variable data for said causal variable;
analyzing said historical product demand information and said de-seasonalized causal variable data for said product to determine a regression coefficient corresponding to said causal variable;
calculating an initial demand forecast for said product during said future sales period from said historical demand information;
receiving a forecast value for said causal variable during said future sales period;
removing the seasonal pattern from said forecast value for said causal variable to generate a de-seasonalized forecast value for said causal variable; and
blending said initial demand forecast, said regression coefficient and said de-seasonalized forecast value for said causal variable to determine a product demand forecast for said product.

8. The system according to claim 7, wherein
said processor step of removing the seasonal pattern from said historical causal variable data associated with said causal variable to generate de-seasonalized causal variable data for said causal variable comprises:
determining average historical values for said causal variable from said historical causal variable data; and
subtracting said average historical values from corresponding historical values within said historical causal variable data; and
said processor step of removing the seasonal pattern from said forecast value for said causal variable to generate a de-seasonalized forecast value for said causal variable comprises:
subtracting a corresponding one of said average historical values from said forecast value for said causal variable.

9. The system according to claim 7, wherein:
said processor step of removing the seasonal pattern from said historical causal variable data associated with said causal variable to generate de-seasonalized causal variable data for said causal variable comprises:
determining average historical values for said causal variable from said historical causal variable data; and
dividing corresponding historical causal variable data values by said average historical values; and
said processor step of removing the seasonal pattern from said forecast value for said causal variable to generate a de-seasonalized forecast value for said causal variable comprises:
dividing, by said computer, said forecast value for said causal variable by a corresponding one of said average historical values.

10. The system according to claim 7, wherein said causal variable comprises a temperature variable.

11. The system according to claim 7, wherein said causal variable comprises an accumulated snowfall variable.

12. The system according to claim 7, wherein said causal variable comprises a precipitation variable.

13. A computer program, stored on a tangible storage medium, for forecasting demand for a product, the program including executable instructions that cause a computer to:
access a computer storage device containing a database of historical product demand information and historical causal variable data for a plurality of products maintaining, on said computer;
identify a causal variable having a seasonal pattern influencing demand for said product;
remove the seasonal pattern from said historical causal variable data associated with said causal variable to generate de-seasonalized causal variable data for said causal variable;
analyze said historical product demand information and said de-seasonalized causal variable data for said product to determine a regression coefficient corresponding to said causal variable;
calculate an initial demand forecast for said product during said future sales period from said historical demand information;
receive a forecast value for said causal variable during said future sales period;
remove the seasonal pattern from said forecast value for said causal variable to generate a de-seasonalized forecast value for said causal variable; and
blend said initial demand forecast, said regression coefficient and said de-seasonalized forecast value for said causal variable to determine a product demand forecast for said product.

14. The computer program, stored on a tangible storage medium, for forecasting demand for a product according to claim 13, wherein:
said step of removing the seasonal pattern from said historical causal variable data associated with said causal variable to generate de-seasonalized causal variable data for said causal variable comprises:
determining average historical values for said causal variable from said historical causal variable data; and
subtracting said average historical values from corresponding historical values within said historical causal variable data; and
said step of removing the seasonal pattern from said forecast value for said causal variable to generate a de-seasonalized forecast value for said causal variable comprises:
subtracting a corresponding one of said average historical values from said forecast value for said causal variable.

15. The computer program, stored on a tangible storage medium, for forecasting demand for a product according to claim 13, wherein:
said step of removing the seasonal pattern from said historical causal variable data associated with said causal variable to generate de-seasonalized causal variable data for said causal variable comprises:
determining average historical values for said causal variable from said historical causal variable data; and
dividing corresponding historical causal variable data values by said average historical values; and
said step of removing the seasonal pattern from said forecast value for said causal variable to generate a de-seasonalized forecast value for said causal variable comprises:
dividing, by said computer, said forecast value for said causal variable by a corresponding one of said average historical values.

16. The computer program, stored on a tangible storage medium, for forecasting demand for a product according to claim 13, wherein said causal variable comprises a temperature variable.

17. The computer program, stored on a tangible storage medium, for forecasting demand for a product according to claim 13, wherein said causal variable comprises an accumulated snowfall variable.

18. The computer program, stored on a tangible storage medium, for forecasting demand for a product according to claim 13, wherein said causal variable comprises a precipitation variable.
